(19) United States
(12) Patent Application Publication
(10) Pub. No.: US 2016/0306392 A1
(43) Pub. Date: Oct. 20, 2016

(54) DISPLAY DEVICE

(71) Applicant: Samsung Display Co., Ltd.

(72) Inventor: Jung Ho PARK, Hwaseong-si (KR)

(21) Appl. No.: 15/002,337

(22) Filed: Jan. 20, 2016

(30) Foreign Application Priority Data
Apr. 16, 2015 (KR) 10-2015-0053839

(51) Int. Cl. G06F 1/16; G06F 3/046; G02B 1/14; G06F 3/044

(52) U.S. Cl. CPC G06F 1/1652; G06F 3/044; G06F 3/046; G02B 1/14; G06F 2203/04102; G06F 2203/04106

(57) ABSTRACT

A display device includes a flexible display panel; a window film; an adhesive layer between the flexible display panel and the window film; a modification layer between the window film and the adhesive layer; and a field generator for supplying an electric field or a magnetic field to the modification layer, wherein hardness of the modification layer is configured to be changed by the electric field or by the magnetic field.

### CROSS-REFERENCE TO RELATED APPLICATION

This application claims priority to, and the benefit of, Korean Patent Application No. 10-2015-0053839 filed in the Korean Intellectual Property Office on Apr. 16, 2015, the entire contents of which are incorporated herein by reference.

### BACKGROUND

1. Field

Embodiments of the present invention relate to a display device.

2. Description of the Related Art

Recently, liquid crystal displays (LCDs) and organic light emitting diode (OLED) displays have been used in devices such as mobile phones, navigation devices, digital cameras, electronic books, portable game machines, and various other kinds of terminals.

In a general display device used in mobile devices, a cover window, which is transparent so that a user may view a display, is provided in front of a display panel. Because the cover window is a constituent element formed at the outermost side of the display device, the cover window should be strong against external impact to protect a display panel and/or the like in the display device.

Furthermore, instead of an existing method that has used a switch or a keyboard as an input device, recently, a structure using a touch panel that is integrally formed with a display screen has been widely distributed, and as compared with an existing mobile device, a surface of the cover window frequently contacts a finger, a stylus, and/or the like, and thus increased hardness of the cover window may be useful.

Recently, research into flexible display devices has been actively conducted, and the cover window applied to the display device may be a foldable and flexible member.

The above information disclosed in this Background section is only for enhancement of understanding of the background of the invention, and therefore it may contain information that does not form prior art.

### SUMMARY

Embodiments of the present invention provide a cover window for a display device that is foldable, and that has surface hardness of a reference level (e.g., a predetermined level) or higher, and a display device including the same.

An exemplary embodiment of the present invention provides a display device including a flexible display panel; a window film; an adhesive layer between the flexible display panel and the window film; a modification layer between the window film and the adhesive layer; and a field generator for supplying an electric field or a magnetic field to the modification layer, wherein hardness of the modification layer is configured to be changed by the electric field or by the magnetic field.

The field generator may be on the flexible display panel.

The field generator may be a touch sensing layer that is configured to generate the magnetic field during operation.

The hardness of the modification layer may be configured to be increased when the electric field or the magnetic field is applied.

100% modulus of the modification layer may be about 5 Gpa or higher at room temperature when the electric field or the magnetic field is applied.

100% modulus of the modification layer may be 0.05 Mpa or less at room temperature when the electric field or the magnetic field is not applied.

The modification layer may include a magnetorheological fluid.

A thickness of the modification layer may be about 10 μm to about 100 μm.

The window film may include a base film and a hard coating layer.

The modification layer may be between the base film and the hard coating layer of the window film.

The field generator may directly connected to the modification layer to supply the electric field or the magnetic field.

The display device may further include a touch sensing layer on the flexible display panel, wherein the field generator is configured to directly supply the electric field or the magnetic field to the modification layer separately from the touch sensing layer.

The display device may be configured to be hardened when the electric field or the magnetic field is applied to the modification layer, and wherein the display device may be configured to be flexible and bendable when the electric field or the magnetic field is not applied to the modification layer.

The adhesive layer may include a pressure reaction adhesive (PSA).

As described above, in the display device according to an exemplary embodiment of the present invention, the display device has a flexible characteristic and maintains surface hardness of a reference level (e.g., a predetermined level) or higher by inserting a modification layer of which hardness varies according to an electric field or a magnetic field between a window film and a display panel.

### BRIEF DESCRIPTION OF THE DRAWINGS

FIG. 1 is a cross-sectional view schematically illustrating a flexible display device according to an exemplary embodiment of the present invention.

FIG. 2 is a cross-sectional view schematically illustrating stress when pressure is applied to the flexible display device according to an exemplary embodiment of the present invention.

FIG. 3 is a cross-sectional view schematically illustrating a state in which the flexible display device according to an exemplary embodiment of the present invention is bent.

FIG. 4 is a schematic cross-sectional view of a flexible display device according to a Comparative Example.

FIG. 5 illustrates a cross section when pressure is applied to the flexible display device according to the Comparative Example.

FIG. 6 illustrates a cover window according to the Comparative Example.

FIG. 7 illustrates a cover window according to an exemplary embodiment of the present invention.

FIG. 8 illustrates a cover window according to another exemplary embodiment of the present invention.

### DETAILED DESCRIPTION

Embodiments of the present invention will be described more fully hereinafter with reference to the accompanying drawings, in which exemplary embodiments of the invention are shown. As those skilled in the art would realize, the described embodiments may be modified in various suitable ways, all without departing from the spirit or scope of the present invention.

In the drawings, the thickness of layers, films, panels, regions, etc., are exaggerated for clarity. Like reference numerals designate like elements (or components) throughout the specification.

It will be understood that when an element or layer is referred to as being “on,” “connected to,” “coupled to,” “connected with,” “coupled with,” or “adjacent to” another element or layer, it can be “directly on,” “directly connected to,” “directly coupled to,” “directly connected with,” “directly coupled with,” or “directly adjacent to” the other element or layer, or one or more intervening elements or layers may be present. Further “connection,” “connected,” etc. may also refer to “electrical connection,” “electrically connect,” etc. depending on the context in which they are used as those skilled in the art would appreciate. When an element or layer is referred to as being “directly on,” “directly connected to,” “directly coupled to,” “directly connected with,” “directly coupled with,” or “immediately adjacent to” another element or layer, there are no intervening elements or layers present.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it will also be understood that when one element, component, region, layer and/or section is referred to as being “between” two elements, components, regions, layers, and/or sections, it can be the only element, component, region, layer and/or section between the two elements, components, regions, layers, and/or sections, or one or more intervening elements, components, regions, layers, and/or sections may also be present.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprise,” “comprises,” “comprising,” “includes,” “including,” and “include,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.” Also, the term “exemplary” is intended to refer to an example or illustration.

As used herein, the term “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

Hereinafter, a display device according to an exemplary embodiment of the present invention will be described in detail with reference to the accompanying drawings.

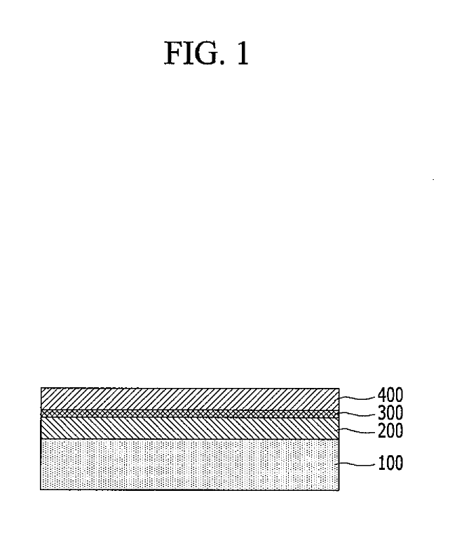

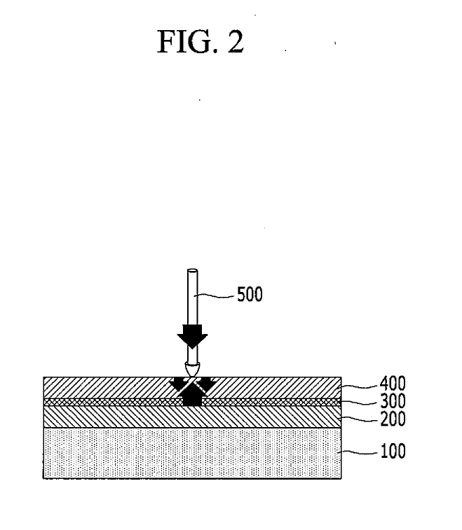

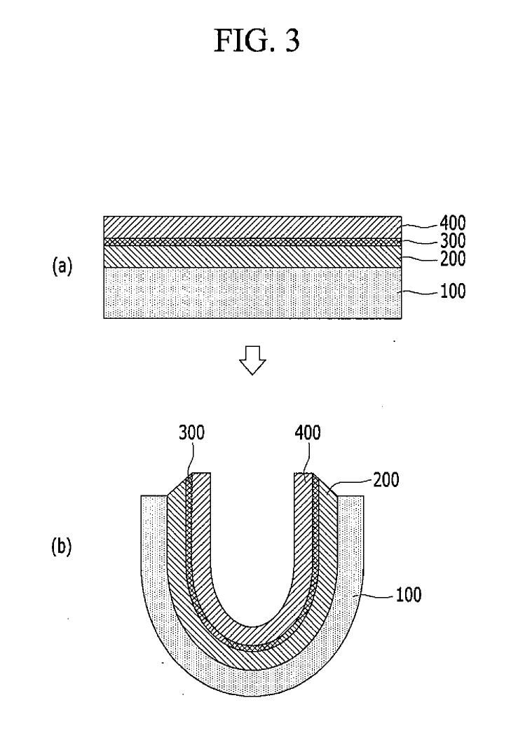

FIG. 1 is a cross-sectional view schematically illustrating a flexible display device according to an exemplary embodiment of the present invention, FIG. 2 is a cross-sectional view schematically illustrating stress when pressure is applied to the flexible display device according to an exemplary embodiment of the present invention, and FIG. 3 is a cross-sectional view schematically illustrating a state in which the flexible display device according to an exemplary embodiment of the present invention is bent.

Referring to FIG. 1, a flexible display device according to an exemplary embodiment of the present invention includes a flexible display panel 100 for displaying an image, an adhesive layer 200, a modification layer 300, and a window film 400.

The flexible display panel 100 includes a plurality of pixels for displaying the image that is processed in the flexible display device. For example, when the flexible display device according to the present embodiment is a mobile terminal, such as a mobile phone, the flexible display device may display an image, such as a user interface (UI) or a graphic user interface (GUI) associated with calling.

The flexible display panel 100 may include a flexible substrate that is made of a plastic material having excellent heat resistance and durability, such as polyethylene naphthalate (PEN), polycarbonate (PC), polyarylate (PAR), polyether imide (PEI), polyether sulfone (PES), polyimide (PI), and/or poly(methylmethacrylate) (PMMA), although the flexible display panel 100 is not limited thereto, and may include a flexible substrate formed of various suitable flexible materials.

The flexible display panel 100 may include a flexile first substrate where a plurality of thin film transistors, a plurality of gate lines, a plurality of data lines, and a plurality of pixel electrodes are located, a flexible second substrate where a plurality of color filters and a common electrode are located, and a liquid crystal layer between the two substrates.

Further, the flexible display panel 100 may include a flexible substrate where a plurality of thin film transistors, a plurality of gate lines, a plurality of data lines, a plurality of pixel electrodes, and a plurality of common electrodes are located. In this case, a microcavity is formed between the pixel electrode and the common electrode, and the liquid crystal layer may be formed in the microcavity.

Further, the flexible display panel 100 may include a plurality of thin film transistors, a plurality of gate lines, a plurality of data lines, and a plurality of organic light emitting diodes that are located on the flexible substrate.

Furthermore, a touch sensing layer may be located on the flexible display panel 100. The touch sensing layer is configured to sense a touch, and may sense the touch when an object approaches or contacts the touch sensing layer. Here, the sensed touch includes not only when an external object, such as a user's hand, directly contacts the touch sensing layer, but also includes when the external object approaches the touch sensing layer, or when the external object hovers over the flexible display panel 100 while approaching the touch sensing layer.

The touch sensing layer includes a touch wire and a driver connected thereto. When the touch sensing layer operates to recognize the touch, current flows in the touch sensing layer, and as a result, an electric field and a magnetic field are formed around the touch sensing layer. Additionally, the electric field or the magnetic field may be formed around the touch sensing layer by a field generator (e.g., an electric field generator or a magnetic field generator).

The adhesive layer 200 is positioned on the flexible display panel 100. The adhesive layer 200 attaches the flexible display panel 100 and the window film 400 to each other, and may include an acryl-based material.

The display device of an embodiment of the present invention is a flexible display device. Accordingly, the adhesive layer 200 may have high elasticity to provide flexibility to the display device and to the window film 400 when the display device is bent. That is, a material having a low elastic/elasticity coefficient should be used as the adhesive.

FIG. 3 schematically illustrates a situation in which the flexible display device of an embodiment of the present invention is bent. Referring to FIG. 3, when the display device is bent, misalignment may occur due to a difference in a curvature between the flexible display panel 100 at the outermost side of the display device, and the window film 400 at the innermost side of the display device.

That is, as illustrated in FIG. 3A, while the display device is flat, widths of respective layers are the same or substantially the same as each other, and edges of the respective layers coincide with each other. However, as illustrated in FIG. 3B, when the display device is bent, the window film 400, which is positioned on the inner side of the display device, is bent further than the flexible display panel 100, which is positioned on the outer side of the display device. Accordingly, the edges of the window film 400 and the flexible display panel 100 do not coincide with each other when the display device is bent.

Misalignment of an outer layer and an inner layer of the display device may cause separation of the respective layers. However, as illustrated in FIG. 3B, the adhesive layer 200 having a low elastic coefficient is flexible, and is stretched to compensate for the misalignment of the respective layers. That is, because the adhesive layer 200 is made of an elastic material, the misalignment between the flexible display panel 100 and the window film 400, as well as stress due to misalignment, are compensated.

When the adhesive layer 200 is made of a material having high elasticity and low modulus (e.g., low elastic modulus), hardness of (e.g., support of) the window film 400 decreases, and depressing (e.g., deformation) is able to occur.

In a typical display device, the cover window is made of a hard glass material. Accordingly, a separate support layer is not generally required. However, in the flexible display device, the cover window is a window film made of a flexible film material that is able to be bent. Accordingly, a base substrate to support the flexible film is useful.

In the display device according to the present embodiment, because the adhesive layer 200 serves as the base substrate of the window film 400, the adhesive layer 200 should have hardness of a reference level (e.g., a predetermined level) or higher. However, as described above, the adhesive layer 200 applied to the flexible display device compensates for the misalignment of the upper and lower layers during bending, and is made of a high-elastic material having low modulus to allow for bending. Accordingly, the adhesive layer 200 might not have sufficient hardness, and may be depressed (e.g., deformed) by externally applied pressure. The depressing/deformation of the adhesive layer 200 further causes a corresponding depressing/deformation of the window film 400, and the depressing of the window film 400 remains as a depressed/deformed spot.

Recently, in the field of display devices, demand for input devices (such as a touch pen) has increased, and in the case of input by a touch pen and/or the like, a depressed spot may be created on the cover window by repeated application of pressure. Further, because the base substrate (that is, the adhesive layer) below the cover window is made of a soft material, a sense of writing (e.g., touch sensing performance) deteriorates when inputting using the touch pen and/or the like. That is, the sense of writing experienced in an analog environment, such as on paper, may not be implemented in a digital environment.

Accordingly, to solve the problem using the flexible display device of the present embodiment, the modification layer 300 is inserted between the adhesive layer 200 and the window film 400. The modification layer 300 is a layer in which a property may be changed based on an external stimulus. When an external stimulus (e.g., a magnetic field, an electric field, ultraviolet light, heat, light, and/or the like) exists at the modification layer 300, various properties of the modification layer 300 may be changed. In the present embodiment, a layer in which hardness is changed by a magnetic field or by an electric field is used as the modification layer 300.

That is, the modification layer 300 according to the present embodiment has a hardness that changes depending on whether the electric field or the magnetic field is applied thereto. When the electric field or the magnetic field is applied, the hardness of the modification layer 300 is increased. Accordingly, the modification layer 300 has a flexible property in a general state (i.e., when the electric field or the magnetic field is not applied), but has a hard property when the electric field or the magnetic field is applied, causing the hardness of the modification layer 300 to be increased.

In an exemplary embodiment of the present invention, when the electric field or the magnetic field is applied to the modification layer 300, 100% modulus of the modification layer 300 may be about 5 Gpa or higher at room temperature. Further, when the electric field or the magnetic field is not applied, 100% modulus of the modification layer 300 may be about 0.05 Mpa or less at room temperature.

In the flexible display device according to the present embodiment, the touch sensing layer of the screen does not operate when the device is bent, but is configured to operate when the display device is unfolded.

Generally, the touch sensing layer is configured to operate when the display device is flat, as illustrated in FIG. 3A. The flexible display device may be stored in the non-operating state by bending or rolling, but in the operating state, generally, the display device is unfolded to be used as a large area.

Accordingly, like FIG. 3A, while the display device is in the flat state, the touch sensing layer of the screen is able to operate. In this case, the magnetic field is generated around the touch sensing layer by operation of the touch sensing layer, and the property of the modification layer 300 is changed by the magnetic field.

As described above, the hardness of the modification layer 300 is increased by the magnetic field. Accordingly, when the pressure is applied to the display device by writing of the touch pen and/or the like, because a lower modification layer 300 is modified by the magnetic field to be in a hard state, the lower modification layer 300 is sufficient to support the window film 400 and/or the like. Accordingly, the depressing/deformation of the window film 400 and the adhesive layer 200 may be prevented, and generation of a depressing phenomenon on the surface of the window film 400 may be reduced or prevented.

FIG. 2 illustrates stress applied to the window film 400 and the modification layer 300 when pressure is applied to the window film 400 in the display device of the present embodiment.

Referring to FIG. 2, in the display device of the present embodiment, when pressure is applied to the window film 400 by the touch pen 500 and/or the like, the hardness of the modification layer 300 is increased by the magnetic or electric field generated in a touch sensing layer formed on the flexible display panel 100. Accordingly, because the modification layer 300 supports the window film 400 with increased hardness, the pressure applied to the window film 400 is not overly transferred to the adhesive layer 200 or to the flexible display panel 100. Therefore, the adhesive layer 200 having low modulus that is located below the window film 400 is not depressed, thereby preventing or reducing generation of the depressed spot of the window film 400 that would otherwise be caused by the depressing of the adhesive layer 200.

Further, because the modification layer 300, when hardened by the magnetic or electric field, supports the window film 400 when the window film 400 is written on by the touch pen and/or the like, a sense of writing may be sufficiently maintained (e.g., resolution or quality of sensing by the touch sensing layer may increase). However, hardness of the modification layer 300 is increased only when the electric field or the magnetic field is applied, and when the electric field or the magnetic field is not applied, the hardness of the modification layer 300 is not increased.

Accordingly, as illustrated in FIG. 3B, when the flexible display device is not used, but is instead stored by bending or rolling, because the electric field or the magnetic field is not applied to the modification layer 300, the hardness of the modification layer 300 is not increased. The modification layer 300 of the display device according to an embodiment of the present invention has high elasticity and a low elastic coefficient while the electric field or the magnetic field is not applied, and as a result, in the state illustrated in FIG. 3B, the modification layer 300 may be easily bent or rolled.

That is, in the display device according to the present embodiment, the modification layer 300 is between the adhesive layer 200 and the window film 400, and thus the hardness of the modification layer 300 is controlled by selectively applying the electric field or the magnetic field, and as a result, the sense of writing is improved, and the depressing is reduced or prevented by increasing the hardness of the modification layer 300 during use of the flexible display device. Therefore, the flexible property of the display device is maintained.

A material used as the modification layer 300 of the display device according to an exemplary embodiment of the present invention may be a magnetorheological fluid. The magnetorheological fluid is a silicon-based gel containing magnetic particles between conductor fibers, and when the electric field or the magnetic field is applied, the layout of the magnetic particles in the inner periphery of the gel is changed by the electric field or the magnetic field, and the structure is hardened due to the layout change of the magnetic particles. That is, the magnetic particles that are randomly distributed are uniformly arranged in a direction of the field by the electric field or the magnetic field, and the strength of the magnetorheological fluid is increased due to the arranged magnetic particles.

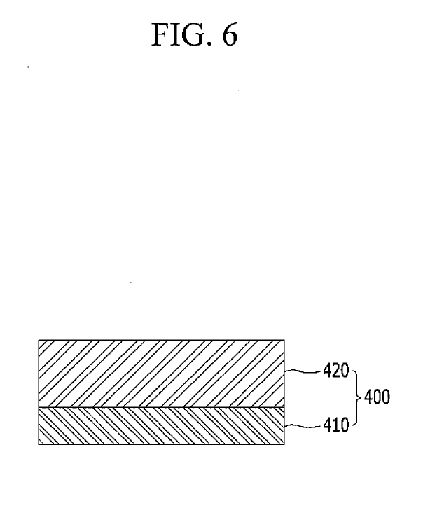

Next, referring to FIG. 6, the window film 400 will be described. The window film 400 may include a base film 410 and a hard coating layer 420 as illustrated in FIG. 6. The base film 410 may be polyimide, although the base film 410 is not limited thereto. In a typical display device, a hard glass is generally used as the cover window. However, when the hard glass is bent in the flexible display device, the hard glass may be broken. Accordingly, in the flexible display device according to an exemplary embodiment of the present invention, the window film 400 includes the base film 410 and the hard coating layer 420, and is used as the cover window. However, because the window film 400 is a film, the window film 400 does not have sufficient strength, and as a result, as described above, there is a problem in that the ability to sense touch deteriorates, or in that a depressed/deformed spot may be generated.

However, the display device according to an exemplary embodiment of the present invention introduces the modification layer 300 between the window film 400 and the adhesive layer 200, and varies the hardness of the modification layer 300 according to existence of an electric field or a magnetic field. That is, to prevent or reduce depressing due to low hardness of the window film 400 and the adhesive layer 200, the material, of which hardness is increased when the electric field or the magnetic field is applied, is used in the modification layer 300.

Further, when the display device is not used, the modification layer 300 has high elasticity and low modulus to be freely bent, and may allow the flexible characteristic of the display device to be maintained.

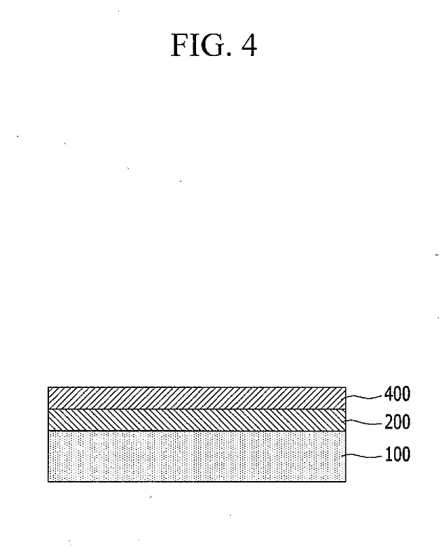

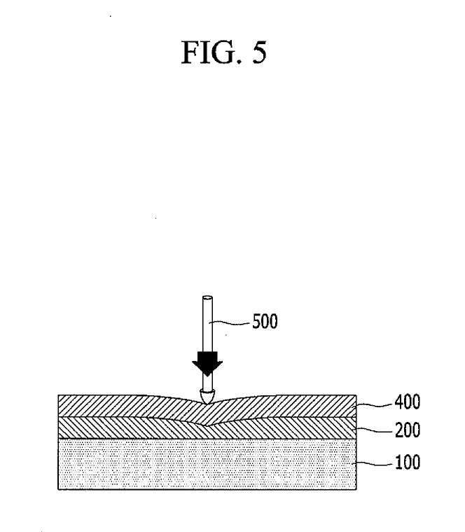

Next, effects of a display device according to a Comparative Example, and effects of a display device according to an exemplary embodiment of the present invention, will be compared with each other with reference to FIGS. 4 and 5.

FIG. 4 is a schematic cross-sectional view of a flexible display device according to the Comparative Example, and FIG. 5 illustrates a cross section when pressure is applied to the flexible display device according to the Comparative Example.

Referring to FIG. 4, a flexible display device according to the Comparative Example includes a flexible display panel 100, an adhesive layer 200, and a window film 400. In this case, the description of the flexible display panel 100, the adhesive layer 200, and the window film 400 is the same or substantially the same as above. That is, the adhesive layer 200 is made of a high-elastic material to compensate for stress and misalignment due to a difference in curvature between the flexible display panel 100 and the window film 400 during bending.

The adhesive layer 200 having low modulus does not sufficiently support the window film 400, and as a result, when pressure is applied to the upper surface of the window film 400 by a touch pen and/or the like, the pressure is transferred to the adhesive layer 200, and a depressed spot and/or the like are caused on the upper surface of the window film 400.

FIG. 5 illustrates a cross section when pressure is applied to the flexible display device according to the Comparative Example.

Referring to FIG. 5, the pressure applied on the window film 400 presses the window film 400 and the adhesive layer 200. Accordingly, even after the pressure is removed, there is a problem in that a depressed spot caused by the depressing of the adhesive layer 200 remains on the window film 400. Further, as illustrated in FIG. 5, in the display device according to the Comparative Example, because the window film 400 and the adhesive layer 200 are depressed by externally applied pressure, there is a problem in that a sense of writing, or touch sensing, deteriorates.

However, as illustrated in FIGS. 1 and 2, in the display device according to an exemplary embodiment of the present invention, the modification layer 300 is located between the window film 400 and the adhesive layer 200. The modification layer 300, supports the window film 400 when the electric field or the magnetic field is applied because the hardness of the modification layer 300 is increased. Accordingly, as illustrated in FIG. 2, even when pressure is applied to the upper surface of the window film 400 by the touch pen 500 and/or the like, the window film 400 and the adhesive layer 200 are not depressed, and as a result, the problem of generation of a depressed spot on the window film 400 is solved. Further, when being written on by the touch pen 500 and/or the like, because the modification layer 300 with increased hardness supports the window film 400, the sense of writing may be improved (e.g., performance of the touch sensing layer may be improved).

Next, effects of the display device according to an exemplary embodiment of the present invention will be described with reference to FIGS. 6 to 8.

FIGS. 6 to 8 illustrate the window film and the support layer according to an exemplary embodiment of the present invention.

FIG. 6 illustrates a cover window according to the Comparative Example. The window film 400 of FIG. 6 includes the base film 410 and the hard coating layer 420.

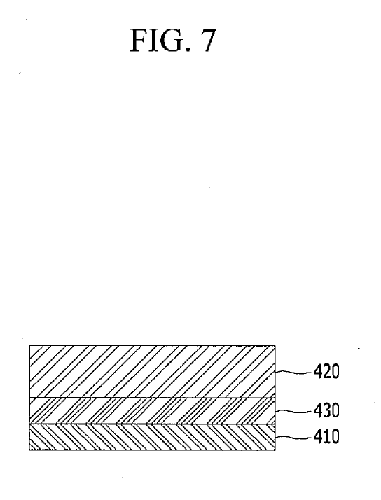

FIG. 7 illustrates a cover window according to an exemplary embodiment of the present invention. In FIG. 7, the support layer 430 is inserted between the base film 410 and the hard coating layer 420 of the window film 400. The support layer 430 is a material having high hardness with a similar configuration to the modification layer 300 described above.

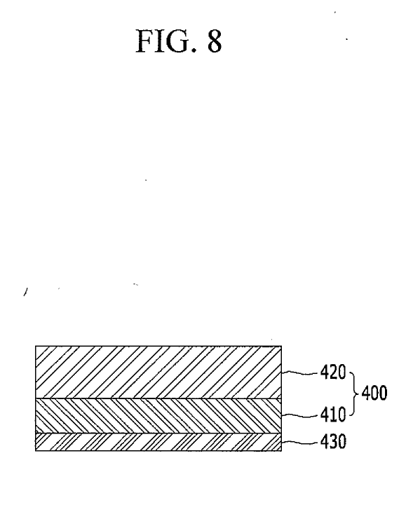

FIG. 8 illustrates a cover window according to another exemplary embodiment of the present invention. In FIG. 8, the support layer 430 is formed below the base film 410 of the window film 400. Similarly, the support layer 430 is a material having high hardness with a similar configuration to the modification layer 300 described above.

The following Tables 1 to 3 illustrate a degree of change in thickness of each layer when pressure is applied in the Comparative Example and in exemplary embodiments of the present invention shown in FIGS. 7 and 8, respectively.

TABLE 1

| Layer | Change Rate (%) |
|---|---|
| Hard coating layer 420 | 0.03 |
| Base film 410 | 0.70 |
| Adhesive layer 200 | 67.68 |
| Polarizer/touch panel | 0.01 |
| Adhesive layer | 37.65 |
| Panel | 0.00 |
| Adhesive layer | 36.24 |
| Panel base film | 0.00 |
| Entire thickness | 16.20 |

Referring to Table 1, in the case of the display device according to the Comparative Example without the modification layer or the support layer, a change rate in thickness of the adhesive layer 200 is high (shown as 67.68%). Further, it can be seen that the entire change rate in thickness is 16.20%.

Table 2 illustrates experimental results, similar to Table 1, with respect to the flexible display device of the embodiment of the present invention illustrated in FIG. 7.

TABLE 2

| Layer | Change Rate (%) |
|---|---|
| Hard coating layer 420 | 0.03 |
| Support layer 430 | 0.47 |
| Base film 410 | 0.40 |
| Adhesive layer 200 | 1.46 |
| Polarizer/touch panel | 0.18 |
| Adhesive layer | 1.15 |
| Panel | 0.09 |
| Adhesive layer | 0.77 |
| Panel base film | 0.05 |
| Entire thickness | 0.53 |

Referring to Table 2, in the display device according to the present embodiment, in which the support layer 430 is between the hard coating layer 420 and the base film 410 of the window film 400, it can be seen that a change rate of the adhesive layer 200 is significantly reduced when compared to the Comparative Example (1.46% as compared with the 67.68% of the Comparative Example of Table 1). Further, it can be seen that the change rate of the entire thickness is 0.53%, and that the change in thickness is significantly reduced as compared with the Comparative Example when pressure is applied.

Table 3 are the experimental results, similar to Table 1, with respect to the flexible display device of the embodiment of the present invention illustrated in FIG. 8.

TABLE 3

| Layer | Change Rate (%) |
|---|---|
| Hard coating layer 420 | 0.15 |
| Base film 410 | 0.21 |
| Support layer 430 | 0.20 |
| Adhesive layer 200 | 0.71 |
| Polarizer/touch panel | 0.09 |
| Adhesive layer | 0.57 |
| Panel | 0.04 |
| Adhesive layer | 0.38 |
| Panel base film | 0.03 |
| Entire thickness | 0.27 |

Referring to Table 3, in the display device according to the present embodiment, in which the support layer 430 is formed below the base film 410 of the window film 400, it can be seen that a change rate of the adhesive layer 200 is significantly reduced (0.71% as compared with the 67.68% of Comparative Example of Table 1). Further, the change rate of the adhesive layer 200 is a value that is significantly reduced (by over half when compared with 1.46%, which is the change rate of the exemplary embodiment of Table 2). Further, it can be seen that the change rate in the entire thickness is 0.27%, and that the change in thickness when pressure is applied is significantly reduced as compared with the Comparative Example and as compared with the exemplary embodiment of FIG. 7.

As shown in Tables 1 to 3, when the support layer 430 is included in the middle of, or on a lower surface of, the window film 400, the change rate in the entire thickness of the display device, and the change rate in thickness of the adhesive layer, are significantly improved. Further, it can be seen that when the support layer 430 is included between the window film 400 and the adhesive layer 200, the change rate of the adhesive layer 200 is increased by a factor of two when compared with the embodiment in which the support layer 430 is included in the middle of the window film 400.

In the present embodiment, when the electric field or the magnetic field is applied, the modification layer 300 with the increased hardness is included between the window film 400 and the adhesive layer 200 to perform the same or substantially the same function as the support layer 430 described in Tables 2 and 3. That is, the modification layer 300 fixes the window film 400 like the support layer 430 because the hardness is increased in an environment where the electric field or the magnetic field is applied, and the modification layer 300 maintains a flexible characteristic through low hardness and high elasticity in an environment where the electric field or the magnetic field is not applied.

The modification layer 300 according to an exemplary embodiment of the present invention is included between the window film 400 and the adhesive layer 200, although the modification layer 300 may be included between the hard coating layer 420 and the base film 410 of the window film 400 as illustrated in FIG. 7.

Further, means of supplying the electric field or the magnetic field to the modification layer 300 is not particularly limited in embodiments of the present invention. That is, as described above, the electric field or the magnetic field generated when the touch sensor positioned on the flexible display panel 100 is driven may be supplied to the modification layer 300. Alternatively, the modification layer 300 may be connected with a separate electric field or magnetic field driver to independently receive the electric field or the magnetic field.

A thickness of the modification layer 300 is not limited, but may be about 10 μm to about 100 μm. When the thickness of the modification layer 300 is less than about 10 μm, the modification layer 300 may not support the window film 400 with sufficient strength, and when the thickness of the modification layer 300 is about 100 μm or higher, flexibility of the display device may be reduced.

While embodiments of the present invention have been described in connection with what is presently considered to be practical exemplary embodiments, it is to be understood that the invention is not limited to the disclosed embodiments, but, on the contrary, is intended to cover various suitable modifications and equivalent arrangements included within the spirit and scope of the appended claims and their equivalents.

Description of Some of the Reference Characters

| | |
|---|---|
| 100: Flexible display panel | 200: Adhesive layer |
| 300: Modification layer | 400: Window film |
| 410: Base film | 420: Hard coating layer |
| 500: Touch pen | 430: Support layer |

What is claimed is:

1. A display device comprising:
a flexible display panel;
a window film;
an adhesive layer between the flexible display panel and the window film;
a modification layer between the window film and the adhesive layer; and
a field generator for supplying an electric field or a magnetic field to the modification layer,
wherein hardness of the modification layer is configured to be changed by the electric field or by the magnetic field.

2. The display device of claim 1, wherein the field generator is on the flexible display panel.

3. The display device of claim 2, wherein the field generator is a touch sensing layer that is configured to generate the magnetic field during operation.

4. The display device of claim 1, wherein the hardness of the modification layer is configured to be increased when the electric field or the magnetic field is applied.

5. The display device of claim 4, wherein 100% modulus of the modification layer is about 5 Gpa or higher at room temperature when the electric field or the magnetic field is applied.

6. The display device of claim 4, wherein 100% modulus of the modification layer is 0.05 Mpa or less at room temperature when the electric field or the magnetic field is not applied.

7. The display device of claim 1, wherein the modification layer comprises a magnetorheological fluid.

8. The display device of claim 1, wherein a thickness of the modification layer is about 10 μm to about 100 μm.

9. The display device of claim 1, wherein the window film comprises a base film and a hard coating layer.

10. The display device of claim 9, wherein the modification layer is between the base film and the hard coating layer of the window film.

11. The display device of claim 1, wherein the field generator is directly connected to the modification layer to supply the electric field or the magnetic field.

12. The display device of claim 1, further comprising a touch sensing layer on the flexible display panel,
wherein the field generator is configured to directly supply the electric field or the magnetic field to the modification layer separately from the touch sensing layer.

13. The display device of claim 3, wherein the display device is configured to be hardened when the electric field or the magnetic field is applied to the modification layer, and
wherein the display device is configured to be flexible and bendable when the electric field or the magnetic field is not applied to the modification layer.

14. The display device of claim 1, wherein the adhesive layer comprises a pressure reaction adhesive (PSA).
